(19) United States
(12) Patent Application Publication
(10) Pub. No.: US 2010/0180812 A1
(43) Pub. Date: Jul. 22, 2010

(54) TRANSLUCENT ILLUMINATED SWIM PLATFORM

(76) Inventor: Justin C. Trippodo, Charlotte, NC (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/487,970

(22) Filed: Jun. 19, 2009

Related U.S. Application Data
(60) Provisional application No. 61/074,416, filed on Jun. 20, 2008.

(51) Int. Cl. B63B 17/00; F21S 4/00

(52) U.S. Cl. 114/362; 362/249.02

(57) ABSTRACT

The present invention provides a system for illuminating a swim platform including a translucent swim platform and an illumination system including at least one light source optically coupled to the translucent swim platform operable for illuminating from within at least a portion of the translucent swim platform causing it to glow. The system further includes a supportive frame for reinforcing the swim platform. The illumination system includes a controller and remote user interface for providing inputs to the controller.

### CROSS-REFERENCE TO RELATED APPLICATION

This application claims priority to U.S. Provisional Patent Application Ser. No. 61/074,416 filed Jun. 20, 2008, the contents of which are incorporated by reference herein.

### TECHNICAL FIELD AND BACKGROUND OF THE INVENTION

1. Field of the Invention

The present invention relates generally to the field of illuminating structures, and more particularly, to illuminating at least a portion of a translucent swim platform for a boat with at least one light source optically coupled with the swim platform, wherein the at least one light source is controlled through a control system.

2. Description of the Related Art

As is known in the art, boat swim platforms function to provide a generally planar surface for aiding a swimmer, diver, wakeboarder, etc. into and out of the water. Conventional swim platforms are typically constructed from opaque materials such as fiberglass and wood, and may have any size and shape defining a surface for supporting the weight of the swimmer, etc. Conventional swim platforms are typically attached about a rear portion of the hull of the boat by one or more brackets or other suitable supporting structure or fasteners. Conventional swim platforms may also function as the supporting surface for mounting other equipment, such as ladders.

As an interest in recreational boating and watersports has increased over the years, so to has an interest in customizing watercraft to personal tastes. While owners are typically able to upgrade audio and video systems with a large variety of aftermarket products to further enjoy their time on the water, there are many other areas of customization yet to be developed.

Accordingly, it would be desirable to develop customized products to change, improve, or enhance systems and structures of a watercraft. In one particular aspect, of which this application relates, it would be desirable to provide a customized lighting system for a watercraft. A customized lighting system that is coupled to a modified existing structure would function to not only increase the visual appearance of that structure and satisfy the need for customization, but also provide illumination for recreational activities and improve safety. While a specific example of illuminating a structure is described herein with reference to a boat, the principles may be applied to other structures of other watercraft within departing from the spirit and scope of the invention.

### BRIEF SUMMARY OF THE INVENTION

In one aspect, the present invention provides an illuminated structure for a boat or other vessel.

In another aspect, the present invention provides a translucent structure adapted to be illuminated by a system described herein.

In yet another aspect, the present invention provides a swim platform, at least a portion of which is translucent, that is illuminated by a light source optically coupled to the swim platform.

In yet another aspect, the present invention provides a lighting system including at least one light source, wherein the lighting system is controlled through a user interface including, but not limited to, a dedicated control panel and/or a remote controller.

In yet another aspect, the present invention provides a lighting system including at least one LED positioned about a translucent portion of a swim platform and optically coupled thereto.

In yet another aspect, the present invention provides an illuminated swim platform for improving the visual appearance of a boat and lighting the surrounding water.

In yet another aspect, the present invention provides an illuminated swim platform system including a supportive frame for providing rigidity to the platform and for mounting the platform to the hull of a watercraft.

These and other aspects of the present invention are achieved in the embodiments disclosed below. According to one embodiment, the present invention provides a system for illuminating a structure including a structure, at least a portion of which is translucent, a frame for supporting the structure and mounting the structure to a watercraft, and a lighting system including a controller and at least one light source optically coupled with the translucent portion of the structure.

According to another embodiment, the present invention provides an illuminated swim platform system including: a translucent swim platform having any desired shape, thickness and transparency; a supportive frame positioned about the platform and operable for supporting the platform, providing rigidity to the platform and mounting the platform to the watercraft; and a lighting system optically coupled to the swim platform, wherein the lighting system includes at least one light source optically coupled to the swim platform controlled through a control system. In one embodiment, the swim platform is made from a Plexiglass™, Lucite™ or like material having a desired optical transparency capable of being illuminated and “glowing.” In another embodiment, the at least one light source is positioned about a portion of the perimeter of the platform. In a preferred embodiment, the lighting system includes a plurality of LEDs positioned about one or more sides of the perimeter of the swim platform and controlled through at least one of a control panel and a remote controller.

According to another embodiment, the present invention provides an illuminated swim platform system including a translucent or transparent swim platform and a lighting system optically coupled to the swim platform and adapted to illuminate at least a portion of the swim platform. The swim platform system may be customized to include any intensity and color of light, and may further function to illuminate a portion of the surrounding water.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of an illuminated swim platform shown mounted to the hull of a boat;

FIG. 2 is a bottom perspective view of the swim platform of FIG. 1 detailing the supportive frame;

FIG. 3 is a schematic diagram illustrating the illuminated swim platform electrically or optically coupled to a lighting system and a control system;

FIG. 4 is a perspective view of a watercraft including an illuminated swim platform; and

FIG. 5 is a perspective view of an illuminated swim platform including a plurality of light sources positioned about the perimeter of the platform.

### DETAILED DESCRIPTION OF THE INVENTION

The present invention will now be described more fully hereinafter with reference to the accompanying figures in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various figures.

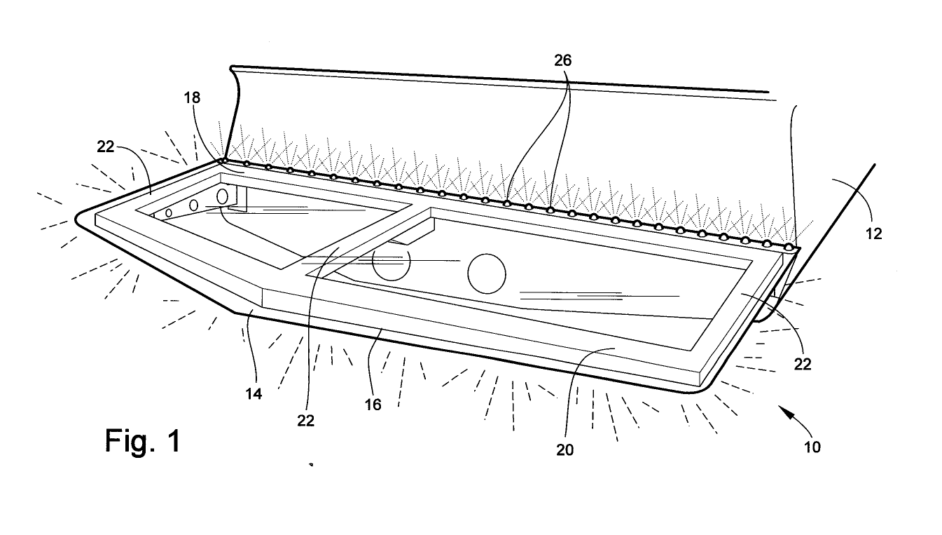

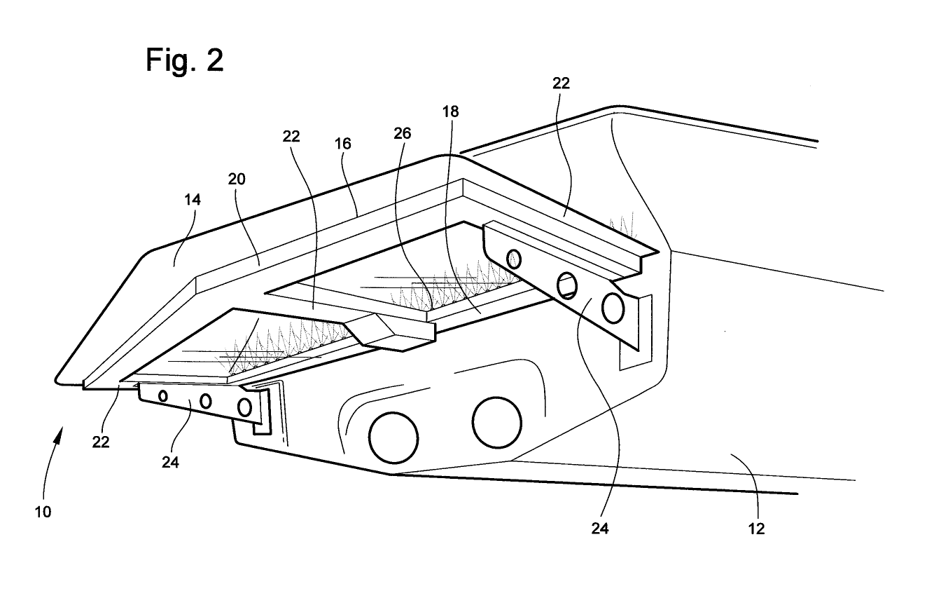

Referring specifically to FIGS. 1 and 2, perspective views of an illuminated swim platform system are shown generally at 10. The system 10 includes a swim platform 14 having any predetermined shape, thickness, rigidity, and optical quality, such as optical transparency or translucency, referred to herein generically as “translucency.” The platform is translucent in that it allows light to pass through, preferably diffusely, causing the platform to “glow.” All or a portion of the swim platform may be translucent and capable of being illuminated. In a preferred embodiment, the swim platform is made from Plexiglass, Lucite or like material having a sufficient strength to support the weight of at least one swimmer. The swim platform may include any type of coating, such as a reflective coating. The swim platform 14 may function not only as a platform, but may also serve as a mounting surface for other structures, such as ladders, cleats, tow hooks, etc. The swim platform is shown mounted to the rear portion of a hull 12 of a watercraft, such as a boat, personal watercraft or other vehicle.

The swim platform 14 is supported by an underlying supportive frame 16 positioned beneath the platform. The frame 16 includes a first member 18 positioned about the hull 12, a second member 20 positioned apart and about parallel to the first member 16, and a plurality of cross members 22 connecting the first and second members 18 and 20. The frame may be constructed from any material including, but not limited to, aluminum and other corrosion resistant materials. The frame 16 is intended to support and reinforce the swim platform. The frame may include additional/fewer members depending on the surface area of the platform and the thickness and strength of the platform material. In one example, a swim platform having a thickness of about 1 inch may require more frame members than a platform having a greater thickness. In an alternative embodiment, the platform 14 may be constructed from a material and have a thickness with a great enough strength and rigidity to obviate the need for a frame. Although the frame members are shown as tubular aluminum, it is intended that the frame members may have any shape and arrangement for supporting the platform.

Referring specifically to FIG. 2, the frame 16 is attached to a plurality of support brackets 24 for mounting the frame to the hull. Although two brackets are shown positioned about each end of the platform 14, additional/fewer brackets may be used to provide the desired level of support. The brackets 24 are preferably made from rigid, corrosion resistant materials, and may made from the same material as the frame. In an alternative embodiment, the frame 16 may be mounted to other structures, and may be mounted directly to the hull. In the case of a frameless swim platform, the platform may be mounted directly to the brackets 24 or to the hull 12. The swim platform may be mounted to the frame and/or the hull using any suitable fastener that preferably does not interfere with the glow of the platform. Examples of fasteners include screws, adhesives and the like. Frame members may be connected by fasteners or may be welded. The support brackets may be mounted to the hull using conventional fasteners and seals.

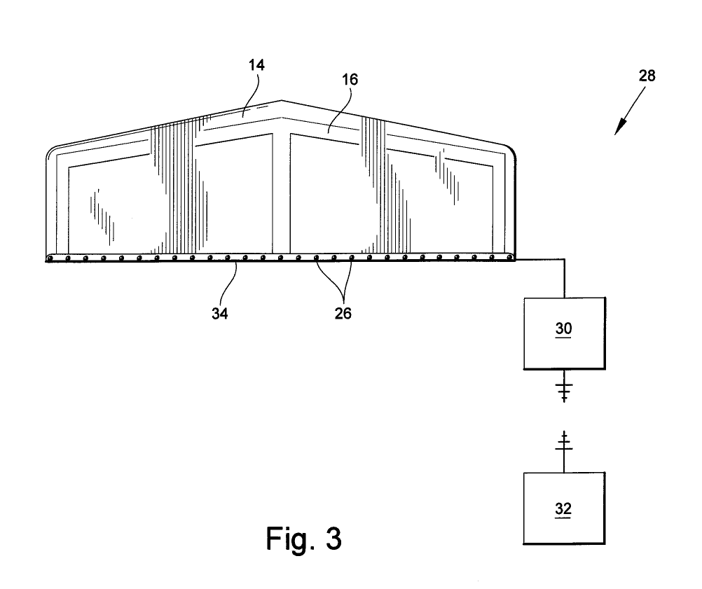

The illuminated swim platform system 10 further includes a lighting system including at least one light source 26 for illuminating the swim platform from within. Referring to FIG. 3, the lighting system 28 includes a lighting controller 30 for controlling the lighting system 10. The light sources 26 are preferably LEDs known to those skilled in the art and positioned about or within the swim platform 14. As shown, the LEDs may be positioned in a row, thus forming an “LED strip” 34 that is positioned about the perimeter and optically coupled to the translucent swim platform 14. The LEDs may optionally be fully or partially embedded within the swim platform. In all embodiments, the LEDs may be positioned in any location sufficient to illuminate the entire swim platform of a portion thereof. At least one interface 32 is provided for operating the control module. The interface 32 may be located in the dash of the boat, in a remote hand-held control unit or in any other location. The interface 32 preferably allows a user to control voltage, intensity, color, periods of activity, and individual LEDs, networks of LEDs and zones of LEDs. The interface 32 may communicate with the controller 30 wirelessly, such as by RF or IR transmission. The remote interface allows a user to input commands to the controller. The controller 30 includes a power source or is coupled with a power source known to those skilled in the art for providing power to the LED network.

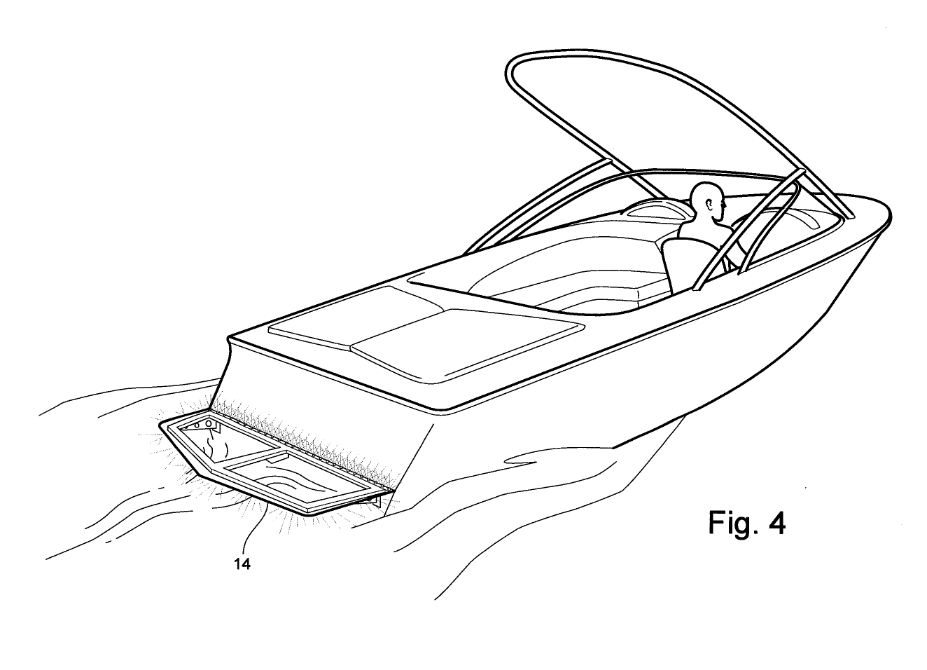

Referring to FIG. 4, the translucent illuminated swim platform 14 is shown mounted to the hull 12 of a boat and in use. The swim platform may be illuminated for entertainment purposes or as a visual signal for safety. Depending upon the intensity of the LEDs or other light source used, the swim platform may illuminate the water adjacent the platform as well. Although LEDs are the preferred light source, other light sources may be substituted without departing from the scope of the invention, such as optical fibers. However, LEDs are the preferred light source for illuminating the swim platform because they produce more light per watt than other sources, light up very rapidly, can emit light of an intended color without requiring filters, can be designed to focus their light through the swim platform, and hold their color steady as they are dimmed. LEDs are also the preferred light source because they are accustomed to frequent on/off cycling, are difficult to damage with the external shock of hitting waves, and have a relatively long useful life of about 35,000-50,000 hours, thus requiring less frequent replacement than other sources.

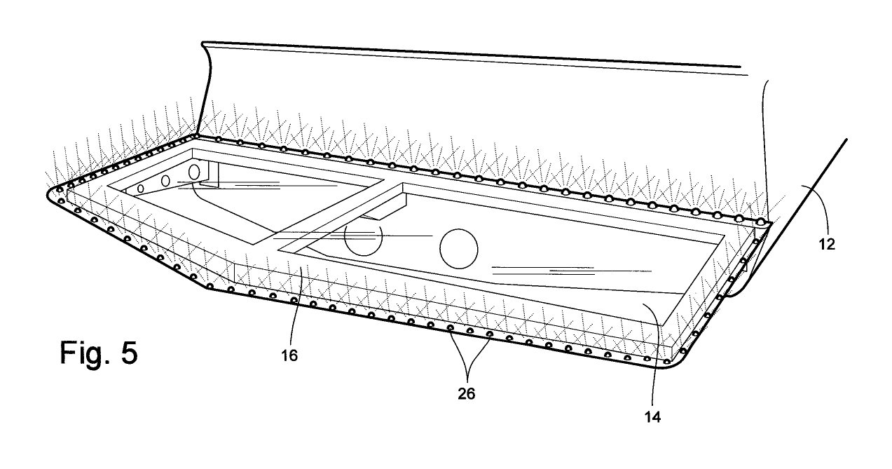

As stated above, the LEDs may be positioned in strips along the perimeter of the platform in optical communication with the platform. The LED strips are preferably directed to focus their light through the platform to provide complete and uniform illumination of the platform. The LEDs or LED strips may be thermally coupled with a heat sink for dissipating heat. The platform may optionally be embedded with LEDs. Referring to FIG. 5, another embodiment of the present invention is shown including a plurality of light sources 26 positioned completely around the perimeter of the swim platform 14 to provide greater and more consistent illumination intensity throughout the platform.

The illuminated swim platform embodiments provided herein may be installed as original equipment or may be retro-fitted.

Although various embodiments have been described in detail, it is envisioned that alternative embodiments and modifications to the embodiments shown may be made without departing from the spirit and scope of the present invention. It is envisioned that all such embodiments be covered by the description provided herein. Furthermore, the foregoing description of the preferred embodiments of the invention and the best mode of practicing the invention are provided for the purpose of illustration only and not for the purpose of limitation.

What is claimed is:

1. A swim platform system for a watercraft, comprising:
a swim platform, at least a portion of which is translucent;
a light source optically coupled to the translucent portion of the swim platform and operable for illuminating the translucent portion; and
a control system coupled with the light source for controlling the operation of the light source.

2. The system according to claim 1, further comprising an underlying frame attached to and supporting the swim platform.

3. The system according to claim 2, further comprising at least one bracket for securing the frame to a hull of the watercraft.

4. The system according to claim 2, wherein the frame is attached to the underside of the swim platform and includes support members interconnected through at least one cross member.

5. The system according to claim 1, further comprising at least one bracket for attaching the swim platform to a hull of the watercraft.

6. The system according to claim 1, wherein the light source includes at least one LED positioned around the perimeter of the swim platform for illuminating the translucent portion.

7. The system according to claim 1, wherein the control system includes at least one of a control panel and remote controller for controlling the light source.

8. The system according to claim 1, wherein the light source is embedded within the translucent portion of the swim platform to illuminate the swim platform from within.

9. The system according to claim 1, wherein the majority of the swim platform is translucent.

10. A swim platform system for a watercraft, comprising:
a translucent swim platform;
a frame for supporting the translucent swim platform from below; and
a light source optically coupled to the swim platform operable for illuminating the swim platform from within and causing at least a portion of the swim platform to glow.

11. The system according to claim 10, further comprising a controller operable for controlling the light source.

12. The system according to claim 11, further comprising a remote user interface for inputting commands to the controller.

13. The system according to claim 10, wherein the frame includes at least one support member and cross member.

14. The system according to claim 10, further comprising a bracket for attaching the frame to a hull of the watercraft.

15. The system according to claim 10, wherein the light source includes a plurality of LEDs arranged around the perimeter of the swim platform.

16. The system according to claim 10, wherein the light source includes a strip of LEDs positioned between a hull of the watercraft and the perimeter of the swim platform.

17. The system according to claim 10, wherein the light source is at least partially embedded within the swim platform.
